(19) United States
(12) Patent Application Publication
(10) Pub. No.: US 2008/0146386 A1
(43) Pub. Date: Jun. 19, 2008

(54) COUPLING FOR ATTACHING A LACROSSE HEAD TO A LACROSSE HANDLE

(76) Inventor: DAVID MORROW, Metamora, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/929,218

(22) Filed: Oct. 30, 2007

Related U.S. Application Data
(62) Division of application No. 11/160,336, filed on Jun. 20, 2005, now abandoned.
(60) Provisional application No. 60/581,319, filed on Jun. 18, 2004.

(51) Int. Cl. A63B 59/02; F16B 7/00

(52) U.S. Cl. 473/513; 403/294

(57) ABSTRACT

A coupling for a lacrosse stick having a lacrosse handle and a lacrosse head includes a handle-mating portion receiving a portion of the lacrosse handle. The coupling also includes a head-mating portion sized for reception within a receiving portion of the lacrosse head. The head-mating portion couples to the handle-mating portion such that the handle-mating portion extends away from the head-mating portion.

### CROSS REFERENCE TO RELATED APPLICATION

This application is a divisional application from U.S. application Ser. No. 11/160,336 filed on Jun. 20, 2005 entitled “A Coupling For Attaching A Lacrosse Head to A Lacrosse Handle” which claims priority from U.S. Provisional Application Ser. 60/581,319 filed Jun. 18, 2004 entitled “A Coupling For Attaching A Lacrosse Head To A Lacrosse Handle”.

### TECHNICAL FIELD

The present invention relates generally to assembly components of a lacrosse stick having a lacrosse head and a lacrosse handle. More particularly, the present invention relates to a coupling for attaching the lacrosse head to the lacrosse handle.

### BACKGROUND OF THE INVENTION

Most current lacrosse heads have sockets formed with a standard octagonal configuration. Specifically, the typical socket includes a generally eight-sided construction with a major axis along a vertical direction and a minor axis along a horizontal direction. In this way, current lacrosse heads are constructed only for attachment to lacrosse handles having similarly constructed end portions, namely octagonal tubes with a major axis along a vertical direction and a minor axis along a horizontal direction. A drawback of the standard socket is that lacrosse handles that are configured or oriented differently than this standard manner cannot be inserted into the sockets and attached to the lacrosse head.

### SUMMARY OF THE INVENTION

It is therefore an advantage of the present invention to provide a coupling for attaching a lacrosse handle to a lacrosse head not sized and shaped for directly attaching to the lacrosse handle.

It is another advantage of the present invention to provide a coupling for providing a versatile and customized lacrosse stick comprising a lacrosse head and a lacrosse handle, both of which are best suited for a lacrosse player.

It is still another advantage of the present invention to provide a coupling that positions a lacrosse handle in a desired orientation with respect to a lacrosse head.

It is yet another advantage of the present invention to provide a coupling that dampens vibrations that can travel from a lacrosse head through a lacrosse handle to a lacrosse player's hands.

It is a further advantage of the present invention to provide a coupling having a simple robust construction that allows for substantially quick and inexpensive manufacture thereof.

It is still a further advantage of the present invention to provide a coupling for a lacrosse stick that is substantially lightweight for maintaining handling characteristics of the lacrosse stick.

It is still yet another advantage of the present invention to provide an inexpensive means for coupling a lacrosse head to a lacrosse handle.

In accordance with the above and the other advantages of the present invention, a coupling for a lacrosse stick having a lacrosse handle and a lacrosse head includes a handle-mating portion for receiving a portion of the lacrosse handle. The handle-mating portion defines a first cross-section and a first central axis. The coupling also includes a head-mating portion sized for reception within a receiving portion of the lacrosse head. The head-mating portion defines a second cross-section and a second central axis. The head-mating portion couples to the handle-mating portion such that the handle-mating portion extends away from the head-mating portion.

Other advantages of the present invention will become apparent when viewed in light of the detailed description of the preferred embodiment when taken in conjunction with the attached drawings and appended claims.

### BRIEF DESCRIPTION OF THE DRAWINGS

For a more complete understanding of this invention, reference should now be made to the embodiments illustrated in greater detail in the accompanying drawings and described below by way of examples of the invention.

FIG. 1 is an exploded view of a lacrosse stick in accordance with one embodiment of the present invention;

FIG. 2 is an exploded view of a lacrosse stick in accordance with another embodiment of the present invention;

FIG. 3 is an exploded view of a lacrosse stick in accordance with another embodiment of the present invention;

FIG. 4 is a top view of a coupling for attaching a lacrosse head to a lacrosse handle in accordance with the embodiment of FIG. 1;

FIG. 5 is front view of the coupling of FIG. 4;

FIG. 6 is a top view of a coupling for attaching a lacrosse head to a lacrosse handle in accordance with the embodiment of FIG. 2;

FIG. 7 is front view of the coupling of FIG. 6;

FIG. 8 is a top view of a coupling for attaching a lacrosse head to a lacrosse handle in accordance with the embodiment of FIG. 3; and

FIG. 9 is front view of the coupling of FIG. 8.

### DETAILED DESCRIPTION OF THE PREFERRED EMBODIMENT

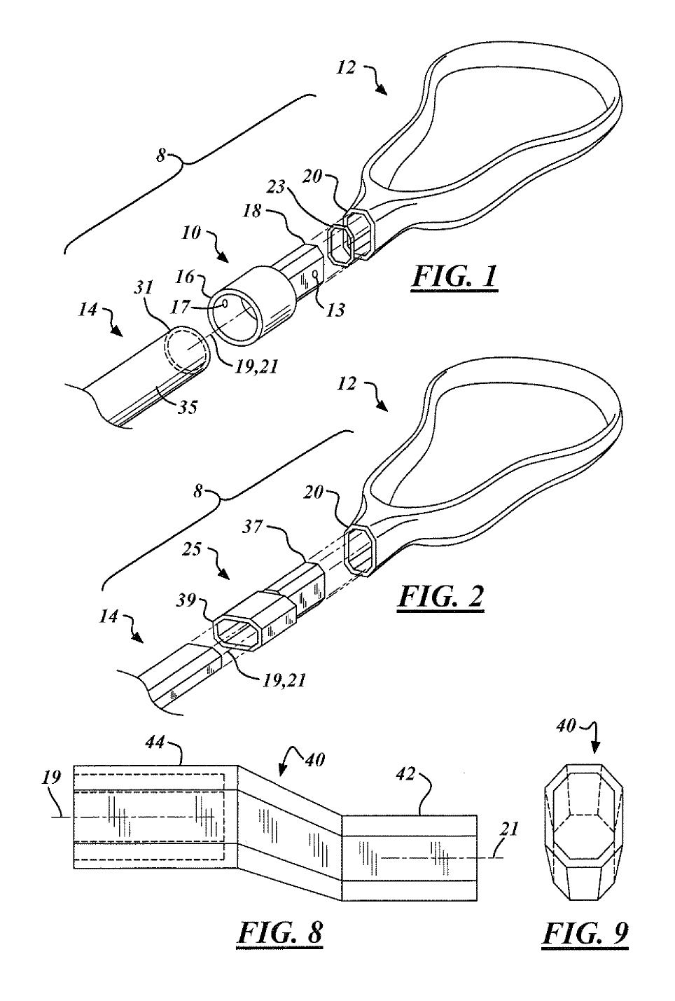

In the following Figures, the same reference numerals are used to identify the same components in the various views. FIGS. 1, 4, and 5 illustrate a lacrosse stick 8 having a coupling 10 for attaching a lacrosse head 12 to a lacrosse handle 14 in accordance with one embodiment of the present invention. In FIG. 1, the coupling 10 has a handle-mating portion 16 for attaching to a lacrosse handle 14 and a head-mating portion 18 for attaching to a lacrosse head 12. In this embodiment, the head-mating portion 18 is a plug extending from the coupling 10. However, the head-mating portion 18 can have various other suitable constructions as desired.

This plug is shaped and sized for insertion into a similarly shaped and sized socket 20, which extends from the lacrosse head 12. In this way, the plug couples to the lacrosse head 12 by a pressure fit engagement. It will also be appreciated that other suitable fasteners, e.g. screw fasteners 13, can be utilized to attach the socket 20 of the lacrosse head 12 to the plug. Also in this embodiment, the handle-mating portion 16 has a sleeve construction for receiving and coupling to an end portion of the handle 14 in a pressure-fit engagement. However, it should be understood that the handle-mating portion 16 may instead have other suitable constructions as desired. The sleeve construction can also be secured to the handle via other suitable fasteners, e.g. screw fasteners 17, as are well known in the art.

In accordance with one embodiment, the coupling 10 includes a vibration-dampening material, e.g. an injection molded elastomeric material. However, it is contemplated that the coupling 10 instead includes various other materials as desired. In another embodiment, the coupling 10 includes a vibration-dampening member 23 coupled thereto for decreasing the amount of vibrations traveling from the lacrosse head 12 to the lacrosse handle 14. For example, the vibration-dampening member may be a foam element operatively coupled between the lacrosse handle 14 and the lacrosse head 12. It is also understood that the vibration dampening may instead be an elastomeric material, a fluid-filled bladder, various other suitable materials, or any combination thereof.

In this embodiment, the head-mating portion 18 and the handle-mating portion 16 of the coupling 10 are respectively shaped and sized for attaching a lacrosse head 12 and a lacrosse handle 14, which may or may not be shaped and sized for directly attaching to each other. For example, as shown in FIG. 1, the coupling 10 is utilized for attaching a socket 20, which has a polygonal construction, to a lacrosse handle 14, which has a larger ellipsoid construction. However, it will be appreciated that the socket 20, the handle 14, and the coupling 10 can have a variety of other suitable shapes and sizes.

To illustrate further, FIGS. 2, 6, and 7 include another coupling 25 having a head-mating portion 37 horizontally ellipsoid and octagonal in cross-section, whereas the handle-mating portion 39 is vertically ellipsoid and also octagonal in cross section.

Referring again to FIGS. 1, 4, and 5, the head-mating portion 18 may be sized for reception within or attachment to a receiving portion or socket 20 (first coupling portion) of the lacrosse head 12, wherein the head-mating portion 18 defines a second cross-section and a second central axis 21. The handle-mating portion 16 is sized for receiving a portion 31 (first end or second coupling portion) of the lacrosse handle 14. Important to note is that the head-mating portion 18 may alternately receive the coupling portion of the lacrosse head, and the coupling portion of the lacrosse handle 14 may alternately receive the handle-mating portion 16.

The head-mating portion 18 is also coupled to the handle-mating portion 16 such that the handle-mating portion 16 extends away from the head-mating portion 18. The head-mating portion 18 defines a second cross-section and a second central axis 21. At least one of the first cross-section and the second cross-section is a circle, an ellipsoid, a triangle, a square, or a polygon.

In addition, it will also be appreciated that the head-mating portion 18 and the handle-mating portion 16 of the coupling 10 can be utilized for positioning the lacrosse handle 14 and the lacrosse head 12 in a desired configuration even when the lacrosse head 12 and the lacrosse handle 14 are compatible for directly attaching to each other.

The lacrosse handle 14 includes a long tube that is construed of a metal material. The handle 14 may be constructed of titanium or aluminum and formed by conventional metal forming process. The handle 14 has a first end 31 that is intended to engage a socket of a lacrosse head and a second end (not shown) that opposes the first end 31. The second end typically has a butt cap fitted thereon. The embodied handle 14 includes a generally octagonal cross section. This allows the handle 14 to fit easily into octagonal shaped socket 20 of the lacrosse head 12 but only when the socket 20 and the handle are designed to couple together; otherwise the coupling 10 is inserted between the head 12 and the handle 14. Further, the handle 14 has an outer wall portion 35, forming the periphery of the handle, and a hollow interior, bounded by the outer wall portion 35. The outer wall 35 in the lacrosse head has a constant thickness throughout the octagonal shape.

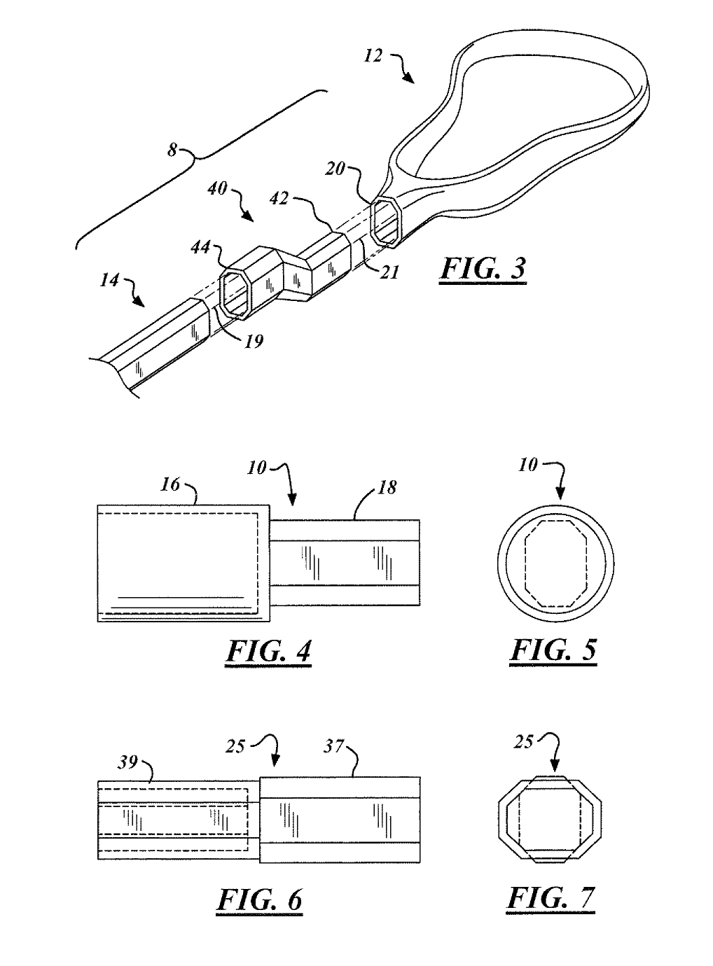

In accordance with another embodiment of the present invention, as shown in FIGS. 3, 8, and 9, the coupling 40 can rotatably offset the lacrosse handle, e.g. ninety (90) degrees, with respect to the socket 20. However, it will be appreciated that the coupling 10 can provide a variety of other suitable offsets or configurations as desired. For example, the coupling 10 can radially offset the lacrosse handle 14 from the socket 20 of the lacrosse head 12. In this way, the coupling offsets the lacrosse head 12 from a longitudinal axis of the lacrosse handle 14. In other words, the second central axis 21 (of the head-mating portion 42) is parallel to and offset from the first central axis 19 (of the handle-mating portion 44).

The coupling 10 thus allows for ready attachment of lacrosse handles having different configurations or orientations to lacrosse heads having standard configurations or orientations.

While particular embodiments of the invention have been shown and described, numerous variations and alternate embodiments will occur to those skilled in the art. Accordingly, it is intended that the invention be limited only in terms of the appended claims.

What is claimed is:

1. A coupling for a lacrosse stick having a lacrosse handle and a lacrosse head comprising:
a handle-mating portion sized for receiving a portion of the lacrosse handle, wherein said handle mating portion defines a first cross-section and a first central axis;
a head-mating portion sized for reception within a receiving portion of the lacrosse head, wherein said head-mating portion defines a second cross-section and a second central axis, said head-mating portion coupled to said handle-mating portion such that said head-mating portion extends away from said handle-mating portion; and
wherein said first central axis and said second central axis are substantially in line.

2. The coupling of claim 1, wherein said first cross-section differs from said second cross-section in at least one of shape and orientation.

3. The coupling of claim 2, wherein one of said first cross-section and said second cross-section comprises a circle, an ellipsoid, a triangle, a square, or a polygon.

4. The coupling of claim 1, further comprising at least one fastener coupled to said head-mating portion adapted to couple to a portion of the lacrosse head.

5. The coupling of claim 1, further comprising at least one fastener coupled to said handle-mating portion adapted to couple to a portion of the lacrosse handle.

6. The coupling of claim 1, wherein one of said first cross-section and said second cross-section is larger than the other.

7. The coupling of claim 1 further comprising a vibration-dampening member coupled to at least one of said handle-mating portion and said head-mating portion.

8. The coupling of claim 7, wherein said vibration-dampening member comprises at least one of a foam element, an elastomer material, and a fluid-filled bladder.

9. The coupling of claim 1, wherein at least one of said handle-mating portion and said head-mating portion comprises a vibration dampening material.

10. A coupling for a lacrosse stick having a lacrosse handle and a lacrosse head comprising:
a handle-mating portion sized for receiving a portion of the lacrosse handle, wherein said handle mating portion defines a first cross-section and a first central axis;
a head-mating portion sized for reception within a receiving portion of the lacrosse head, wherein said head-mating portion defines a second cross-section and a second central axis, said head-mating portion coupled to said handle-mating portion such that said head-mating portion extends away from said handle-mating portion;
at least one fastener coupled to said head-mating portion adapted to couple to a portion of the lacrosse head;
a vibration-dampening member coupled to at least one of said handle-mating portion and said head-mating portion; and
wherein said first central axis and said second central axis are substantially in line.

11. The coupling of claim 10, wherein said first cross-section differs from said second cross-section in shape.

12. The coupling of claim 11, wherein one of said first cross-section and said second cross-section comprises a circle, an ellipsoid, a triangle, a square, or a polygon.

13. The coupling of claim 10, wherein said vibration-dampening member comprises at least one of a foam element, an elastomeric material, and a fluid-filled bladder.

14. A lacrosse stick comprising:
a lacrosse head comprising a first coupling portion and defining a first major axis;
a lacrosse handle comprising a second coupling portion and a second major axis;
a coupling comprising a handle-mating portion and a head-mating portion,
said handle-mating portion sized for attaching to said second coupling portion, wherein said handle mating portion defines a first cross-section and a first central axis substantially linear with said second major axis,
said head-mating portion sized for attaching to said first coupling portion, wherein said head-mating portion defines a second cross-section and a second central axis substantially linear with said first major axis, said head-mating portion extends away from said handle-mating portion;
at least one fastener coupling said head-mating portion to said first coupling portion; and
a vibration-dampening member coupled to at least one of said handle-mating portion and said head-mating portion.
